(19) United States
(12) Patent Application Publication
(10) Pub. No.: US 2007/0095947 A1
(43) Pub. Date: May 3, 2007

(54) Injection nozzle with an improved injection function and method for producing an injection nozzle

(76) Inventor: Simone Sivieri, San Vincenzo (IT)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 10/558,339

(22) PCT Filed: Apr. 15, 2004
(86) PCT No.: PCT/EP04/50529

§ 371 Date: Oct. 4, 2006

(30) Foreign Application Priority Data
May 26, 2003 (EP) 03011856.6

(51) Int. Cl. F02M 61/00; F02M 51/00

(52) U.S. Cl. 239/533.12; 239/585.1

(57) ABSTRACT

An injection nozzle of a valve injector has a hollow cylindrical shape and a bottom with a circular sealing face. An injection port is arranged in the bottom and the injection port discharges by an injection opening in an inner face of the injection nozzle. The injection port is arranged at a given angle to a longitudinal axis of the injection nozzle. The sealing face is adjacent to a blind hole. The injection opening is arranged in a bore face of the blind hole and the injection opening is asymmetrically arranged with regard to the longitudinal axis of the injection nozzle. This shape provides an improved injected fuel spray.

### CROSS-REFERENCE TO RELATED APPLICATIONS

This application is a continuation of co-pending International Application No. PCT/EP2004/050529 filed Apr. 15, 2004, which designates the United States of America, and claims priority to European application number 03011856.6 filed May 26, 2003, the contents of which are hereby incorporated by reference in their entirety.

### TECHNICAL FIELD

The invention describes an injection nozzle for an injection valve with a hollow cylindrical shape comprising a bottom with a circular sealing face, whereby an injection port is arranged in the bottom and the injection port discharges over an injection opening in an inner face of the injection nozzle, whereby the injection port is arranged at a given angle to a longitudinal axis of the injection nozzle.

### BACKGROUND

With respect to gasoline engines satisfying social needs such as high power, high fuel efficiency and low pollution, engines using fuel injection valves of the direct gas injection type have been generally recognized. Although there is a continuous development of fuel injectors, many problems still remain to be solved, such as high-pressure injection technology, pressure-tightness and heat resistance in order to use the fuel injection for directly injecting fuel into a combustion chamber.

The fuel injection valve of the direct gas injection type is composed with a nozzle having a fuel injection port facing directly to the fuel chamber, a valve body for opening and closing the fuel channel, a magnetic coil for closing the valve body, a spring for closing the valve and a yoke, and a core for forming the magnetic circuit. In addition, a swirler at the upper stream of the valve sheet for providing the fuel with a swirling force and a spring adjuster for adjusting the quantity of dynamic fuel injection are included.

A structural characteristic of this fuel injection valve of the direct gas injection type includes that, as the fuel pressure reaches such a high value as 3-10 MPa in order to establish the grain refinement of the fuel spray liquid drops for reducing the evaporation time and the high efficiency in fuel injection for reducing the fuel injection time, the pressure tightness and the oil tightness are enhanced in comparison to the fuel injection valve of conventional gas injection types with the fuel pressure amounting to about 0.3 MPa, and that the heat resistance and the gas tightness are enhanced due to the nozzle being exposed directly to the combustion gas.

An injection nozzle is known from the U.S. Pat. No. 6,092,743. U.S. Pat. No. 6,494,388 and DE 199 07 859 A1 disclose a fuel injection nozzle that comprise a disk-shaped valve seat element at its downstream end. On the upstream side of the valve seat element a swirl disk is arranged that has an interior opening area that runs over the entire axial thickness of the swirl element. The interior opening area comprises a swirl chamber, through which a valve needle extends, and a multiplicity of swirl channels discharging into the swirl chamber. On the upstream side of the swirl element a guide element is arranged that comprises a central guide opening for guiding the valve needle and a multiplicity of recesses distributed over the circumference of the guide element. Fuel flows through the recesses of the guide element into the swirl channels and from these into the swirl chamber. Fuel can be injected from the swirl chamber through an outlet opening in the valve seat element, if the valve needle is not in its closed position sealing the outlet opening.

### SUMMARY

An object of the present invention is to provide an injection nozzle for a fuel injection valve which establishes an optimised fuel spray.

The object of the invention can be achieved by an injection nozzle for an injection valve comprising a hollow cylindrical shape with a bottom with a circular sealing face, an injection port comprising an injection opening in an inner face of the injection nozzle, the injection port being arranged in the bottom at a given angle to a longitudinal axis of the injection nozzle, wherein the injection opening is asymmetrically arranged regarding a central longitudinal axis of the injection nozzle, a blind hole adjacent to the sealing face, a bore face of the blind hole in which the injection opening is arranged, a swirl disk arranged on the bottom of the injection nozzle and fixed to the injection nozzle, the swirl disk comprising a central needle bore for receiving a needle, and channels, wherein a channel comprises an inlet opening and an outlet opening, wherein the inlet opening is arranged on an upper face of the swirl disk, and the outlet opening discharges laterally in the needle bore, wherein the channels are arranged tangentially to a border of the needle bore, and wherein the outlet opening of one channel is arranged in a plane that is arranged parallel to a second plane that is defined by a direction of the injection port.

The injection port may have a cylindrical shape. The blind hole may have a conical shape and may be arranged symmetrically to the central longitudinal axis of the injection nozzle. The injection opening can be arranged in the central longitudinal axis. Several channels can be symmetrically arranged around the needle bore. A center point of the injection opening can be arranged beside the central longitudinal axis of the injection nozzle.

The object can also be achieved by a method for producing an injection nozzle comprising the steps of producing a cylindrical recess in a nozzle blank, producing blind hole with a conical end face in a bottom of the nozzle, machining an annular sealing face surrounding the end face, producing an injection port in the bottom by an electro discharge process, arranging an opening of the injection port in the end face near the sealing face, arranging a swirl disk in the nozzle between a fuel inlet and the blind hole, and fixing the swirl disk in a predetermined rotational position to the opening of the injection port in such a way that an outlet opening of a channel of a swirl disk is arranged in a plane that is arranged parallel to a second plane that is defined by the direction of the injection port and that the swirl disk is fixed to the nozzle in this position to the injection opening.

The injection nozzle, thus, comprises a swirl disk that is arranged on the bottom of the nozzle between a fuel inlet and the blind hole. The swirl disk comprises the central needle bore for receiving a needle and channels for guiding fuel in a radial direction to the central needle bore. The channel comprises an inlet opening and an outlet opening. The inlet opening is arranged on an upper face of the swirl disk and the outlet opening discharges laterally into the central needle bore. The outlet opening of the channel is arranged in a plane that is defined by the direction of the injection port and the swirl disk is fixed in a predetermined position to the injection opening. The injection nozzle according to claim 1 has the advantage that the injected fuel spray has a more homogeneous disposition of the fuel with a smaller average size.

In a preferred embodiment of the invention, the injection nozzle comprises an injection port that has a cylindrical shape.

In a further preferred embodiment of the invention, the blind hole has a conical shape and is arranged symmetrically to the longitudinal axis of the injection nozzle. This embodiment is favourably produced.

In a preferred embodiment of the invention, the injection opening of the injection port is arranged at least partially along the longitudinal axis of the injection nozzle. The improved function of the injection nozzle is achieved by a symmetrical arrangement of the injection opening by means of which the injection port discharges into the injection nozzle.

In a further preferred embodiment of the injection nozzle, a central part of the injection opening of the injection port is at least in one direction arranged alongside the longitudinal axis of the injection nozzle, although this feature improves the spray characteristics of the injected fuel.

In a further preferred embodiment of the invention, the injection port is operated at the bottom of the nozzle by an electro-discharge process and the opening of the injection port by means of which the injection port discharges into the interior of the injection nozzle.

### BRIEF DESCRIPTION OF THE DRAWINGS

FIG. 1 is a vertical cross-section of an injection valve with an injection nozzle.

FIG. 2 is a vertical, cross-sectional view of the bottom of the nozzle and of the injection port.

FIG. 3 is a schematic representation of a swirl disk above an opening of an injection port.

### DETAILED DESCRIPTION

Before one embodiment of the invention is explained in more detail, it is to be understood that the invention is not limited in this application to the details of construction and the arrangements of the components set forth in the following description or illustrated in the drawings. The invention is capable of other embodiments and of being practised or being carried out in various ways.

A preferred embodiment of a fuel injection according to the present invention will now be described with reference to the drawings.

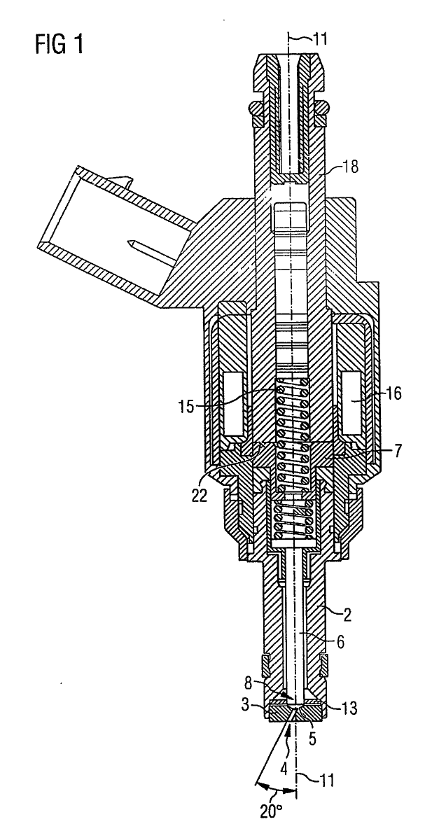

FIG. 1 shows a longitudinal view of a fuel injector 1 used in a motor vehicle engine. The fuel injector is basically symmetrical to a central symmetry axis 11. The injection valve includes a nozzle 2. Inside of the nozzle 2, a bottom plate 3 is arranged adjacent to a lower end of the nozzle 2. The bottom plate 3 includes an injection port 4 that is arranged at an angle of 20° to the central symmetry axis 11. The injection port 4 provides fluid communication between an interior of the fuel injector 1 and a combustion chamber of a motor vehicle engine. At an inner side of the bottom plate 3, a valve seat 5 is arranged. Upon the bottom plate 3, a swirl disk 13 is arranged. The swirl disk 13 comprises a central hole 14 through which the closing member 8 of the needle 6 is guided to the valve seat 5.

The nozzle 2 is fixed to a valve body 22 that houses a needle assembly. The needle assembly comprises an armature 7 that is connected to a closing member 8 by a needle 6. The closing member 8 is a tip of the needle 6 that is dedicated to the valve seat 5. The armature 7 can be moved within the valve body 22 along a longitudinal axis of the fuel injector 1. Depending on the position of the armature 7, the closing member 8 is in a closed position, biased against the valve seat 5, closing the injection port 4 and preventing a fuel injection. In an open position, the needle 6 is lifted off the valve seat 5 and fuel is injected over the injection port 4 by the injection.

The injection valve 1 further includes a electromagnetic coil assembly 16 that encircles a portion of an inlet tube 18 and is housed within the valve body 22. The electromagnetic coil assembly 16 can be selectively charged to create a magnetic field attracting the armature 7 towards a spring 15, lifting off the valve seat 5. The biasing force of the spring 15 is overcome in such a way that the closing member 8 is raised from the valve seat 5, allowing fuel to flow through injection port 4 into the combustion chamber. The needle 8 remains in the open position until the charge is removed from the electromagnetic coil assembly 16 at which point the spring 15 biases the needle 6 with its closing member 8 back into the valve seat 5.

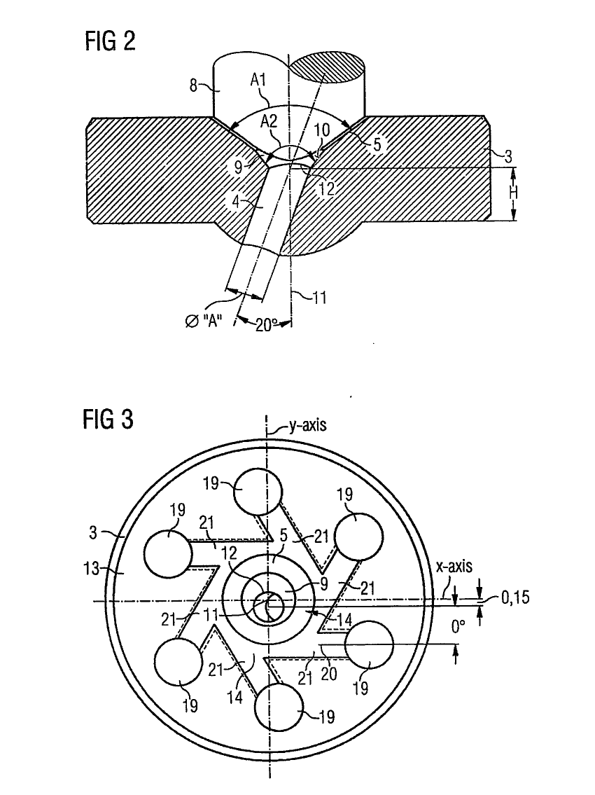

FIG. 2 depicts a sectional view of a lower part of the fuel injection valve with the bottom plate 3 and the closing member 8 in more detail. The bottom plate 3 comprises the valve seat 5 that is arranged in an annular conical shape. The valve seat 5 passes over to a blind hole 9. The blind hole 9 has a conical shape and comprises an annular, conical end face 10. The blind hole 9 and the valve seat 5 are arranged in a radial symmetrical position to the symmetry axis 11 of the injection nozzle 2.

The injection port 4 discharges into the blind hole 9. The injection port 4 is arranged at a predetermined angle to the symmetry axis 11. In this embodiment, the predetermined angle is about 20°. Depending on the embodiment of the injection valve, also other angle values could be used. The injection port 4 has a circular cross-section vertically to its longitudinal axis. The injection port 4 discharges over an injection opening 12 in the blind hole 9. The shape of the border of the injection opening 12 is far more an elliptical than a circular shape due to the conical shape of the blind hole 9 and the inclined arrangement of the injection port 4 related to the symmetry axis 11.

The injection opening 12 is, however, always arranged on the end face 10 of the blind hole 9 and not on the face of the valve seat 5. There is at least a minimum distance between the face of the valve seat 5 and the injection opening 12, ascertaining a tight closing of the injection valve by the closing member 8.

The angle of the conical shape of the valve seat 5 is larger than the angle of the conical shape of the blind hole 9. Therefore, the fuel that flows into the injecting port 4 is firstly guided by the first conical shape of the valve seat 5 and secondly guided by a second conical shape of the blind hole 9. This leads to an increasing velocity of the fuel by progressive stages. After the second conical shape of the blind hole 9, the fuel passes in the injection port 4. At the transition of the blind hole 9 to the injection port 4, the flow direction of the fuel changes according to the inclined arrangement of the injection port 4. The first angle A1 of the valve seat 5 is greater than the second angle A2 of the blind hole 9.

FIG. 3 shows a top view on the swirl disk 13 that is arranged on the bottom plate 3. In the middle of the bottom plate 3, the valve seat 5 and the blind hole 9 are arranged. In FIG. 3, the injection opening 12 is arranged with its central part of the symmetry axis 11.

The swirl disk 13 comprises six channels 15 that are symmetrically arranged around the central hole 14. Each channel 15 comprises an inlet opening 19 that is arranged near the outer border of the swirl disk 13. The channel 15 leads to an outlet opening 21 to the central hole 14 by a straight part 20. The outlet opening 21 discharges laterally in the central hole 14 that is a needle bore. The channels 15 are arranged tangentially to a border of the needle bore. The straight part 20 of at least one of the channels 15 is arranged in parallel to an x-axis of the cross section. The at least one channel 15 is arranged in a plane that is parallel to the plane that is defined by the injection part 4.

In a preferred embodiment of the invention, a swirl disk 13 is arranged in a rotary position in such a way that a channel 15 is arranged vertically to the y-axis. The injection opening 12 is arranged at a position of a given distance to the symmetry axis 11 in a direction of the y-axis. The x-axis and the y-axis define at their crossing point the position of the symmetry axis 11. The x- and the y-axis stay perpendicularly to each other.

Respectively, two channels 15 of the six channels 15 of the swirl disk 13 are arranged in parallel to each other by their straight parts 20. The inlet openings 19 of the parallel channels 15 are arranged at opposite sides in comparison to the centre hole 14. The orientation of the straight parts 20 of adjacent channels 15 are arranged at an angle of approximately 60° to each other. Preferably, a middle axis of the injection port 4 is arranged in a plane that is arranged vertically to the y-axis.

Experiments have shown that an orientation of the swirl disk 13 related to the injection opening 12 as shown in FIG. 3, results in best behaviour for the injection fuel spray. Therefore, the swirl disk 13 is arranged on the bottom plate 3 as shown in FIG. 3 and then fixed relative to the bottom plate 3. The fixing of the swirl disk 13 to the bottom plate 3 is preferably achieved by a laser-welded connection between the swirl disk 13 and the bottom plate 3.

1. An injection nozzle for an injection valve comprising:
a hollow cylindrical shape with a bottom with a circular sealing face,
an injection port comprising an injection opening in an inner face of the injection nozzle, the injection port being arranged in the bottom at a given angle to a longitudinal axis of the injection nozzle, wherein the injection opening is asymmetrically arranged regarding a central longitudinal axis of the injection nozzle,
a blind hole adjacent to the sealing face,
a bore face of the blind hole in which the injection opening is arranged,
a swirl disk arranged on the bottom of the injection nozzle and fixed to the injection nozzle, the swirl disk comprising a central needle bore for receiving a needle, and channels, wherein a channel comprises an inlet opening and an outlet opening, wherein the inlet opening is arranged on an upper face of the swirl disk, and the outlet opening discharges laterally in the needle bore, wherein the channels are arranged tangentially to a border of the needle bore, and
wherein the outlet opening of one channel is arranged in a plane that is arranged parallel to a second plane that is defined by a direction of the injection port.

2. An injection nozzle according to claim 1, wherein the injection port has a cylindrical shape.

3. An injection nozzle according to claim 1, wherein the blind hole has a conical shape and is arranged symmetrically to the central longitudinal axis of the injection nozzle.

4. An injection nozzle according to claim 1, wherein the injection opening is arranged in the central longitudinal axis.

5. An injection nozzle according to claim 1, wherein several channels are symmetrically arranged around the needle bore.

6. An injection nozzle according to claim 1, wherein a center point of the injection opening is arranged beside the central longitudinal axis of the injection nozzle.

7. A method for producing an injection nozzle comprising the steps of:
producing a cylindrical recess in a nozzle blank,
producing a blind hole with a conical end face in a bottom of the nozzle,
machining an annular sealing face surrounding the end face
producing an injection port in the bottom by an electro discharge process,
arranging an opening of the injection port in the end face near the sealing face,
arranging a swirl disk in the nozzle between a fuel inlet and the blind hole, and
fixing the swirl disk in a predetermined rotational position to the opening of the injection port in such a way that an outlet opening of a channel of a swirl disk is arranged in a plane that is arranged parallel to a second plane that is defined by the direction of the injection port and that the swirl disk is fixed to the nozzle in this position to the injection opening.

8. A method for producing an injection nozzle for an injection valve comprising the steps of:
providing a hollow cylindrical shape with a bottom with a circular sealing face,
providing an injection port comprising an injection opening in an inner face of the injection nozzle,
arranging the injection port in the bottom at a given angle to a longitudinal axis of the injection nozzle,
arranging the injection opening asymmetrically regarding a central longitudinal axis of the injection nozzle,
providing a blind hole adjacent to the sealing face,
providing a bore face of the blind hole in which the injection opening is arranged,
providing a swirl disk arranged on the bottom of the injection nozzle and fixed to the injection nozzle, the swirl disk comprising a central needle bore for receiving a needle, and channels, wherein a channel comprises an inlet opening and an outlet opening, wherein the inlet opening is arranged on an upper face of the swirl disk, and the outlet opening discharges laterally in the needle bore, wherein the channels are arranged tangentially to a border of the needle bore, and
arranging the outlet opening of one channel in a plane that is arranged parallel to a second plane that is defined by a direction of the injection port.

9. A method according to claim 8, wherein the injection port has a cylindrical shape.

10. A method according to claim 8, wherein the blind hole has a conical shape and is arranged symmetrically to the central longitudinal axis of the injection nozzle.

11. A method according to claim 8, wherein the injection opening is arranged in the central longitudinal axis.

12. A method according to claim 8, wherein several channels are symmetrically arranged around the needle bore.

13. A method according to claim 8, wherein a center point of the injection opening is arranged beside the central longitudinal axis of the injection nozzle.
